(19) United States
(12) Patent Application Publication
(10) Pub. No.: US 2018/0375899 A1
(43) Pub. Date: Dec. 27, 2018

(54) AUTOMATED SECURITY POLICY INFORMATION POINT CONTENT GENERATION

(71) Applicant: Honeywell International Inc., Morris Plains, NJ (US)

(72) Inventor: Patricia Brett, Fort Washington, PA (US)

(21) Appl. No.: 15/629,486

(22) Filed: Jun. 21, 2017

(51) Int. Cl. H04L 29/06; G06F 17/30

(52) U.S. Cl. CPC H04L 63/20; G06F 17/30312; H04L 63/10

(57) ABSTRACT

This disclosure provides an apparatus and method for automated security policy information point content generation, including but not limited to in industrial control systems and other systems. A method includes receiving, by a security system, resource information that describes automation device type resources. The method includes receiving, by the security system, a Policy Information Point (PIP) device type template. The method includes creating at least one record, by the security system, in a PIP database according to the resource information and the PIP device type template.

### TECHNICAL FIELD

This disclosure relates generally to security techniques. More specifically, this disclosure relates to systems and methods for enhanced security policies and operations.

### BACKGROUND

A Policy Information Point (PIP) is a system entity that acts as a source of attribute values (e.g., a resource, subject, or environment). The security PIP can be used to automate access (authorization) decisions in a platform-neutral manner to provide access by a device, user, or application to other devices, systems, applications or databases. Improved processes are desirable.

### SUMMARY

This disclosure provides an apparatus and method for automated security policy information point content generation, including but not limited to in industrial control systems and other systems. A method includes receiving, by a security system, resource information that describes automation device type resources. The method includes receiving, by the security system, a Policy Information Point (PIP) device type template. The method includes creating at least one record, by the security system, in a PIP database according to the resource information and the PIP device type template.

Disclosed embodiments include a system comprising a processor and a memory, configured to perform processes as described herein. Disclosed embodiments also include a non-transitory machine-readable medium encoded with executable instructions that, when executed, cause one or more processors of a system to perform processes as disclosed herein.

In various embodiments, the method also includes instantiating a device instance record from the at least one record in the PIP database. In various embodiments, the method also includes creating and storing a security access policy definition for one or more system resources based on the PIP database. In various embodiments, the security access policy definition is also based on a Security Policy Information Point Data Base policy template. In various embodiments, the record in the PIP database is also based on other PIP information, the other PIP information including at least one of user classes, information defining the activities permitted for users, and context-specific attributes. In various embodiments, the resource information is included in a set of resource files that includes at least one of device type resource information that describes automation device type resources, a set of Standardized General Markup Language (SGML) files, a set of files based on a consortium defined specification, a set of files based on a particular singular industry domain topology, or a set of cross-domain ontologies intended to provide cross-domain interoperability, or a set of vendor custom defined files. In various embodiments, at least one record contains default attribute-based access controls (ABAC) associated with resource types defined by and/or associated with a particular device type.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIGS. 2 and 3 illustrates logical elements of systems in accordance with disclosed embodiments; and

FIG. 4 illustrates a process in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

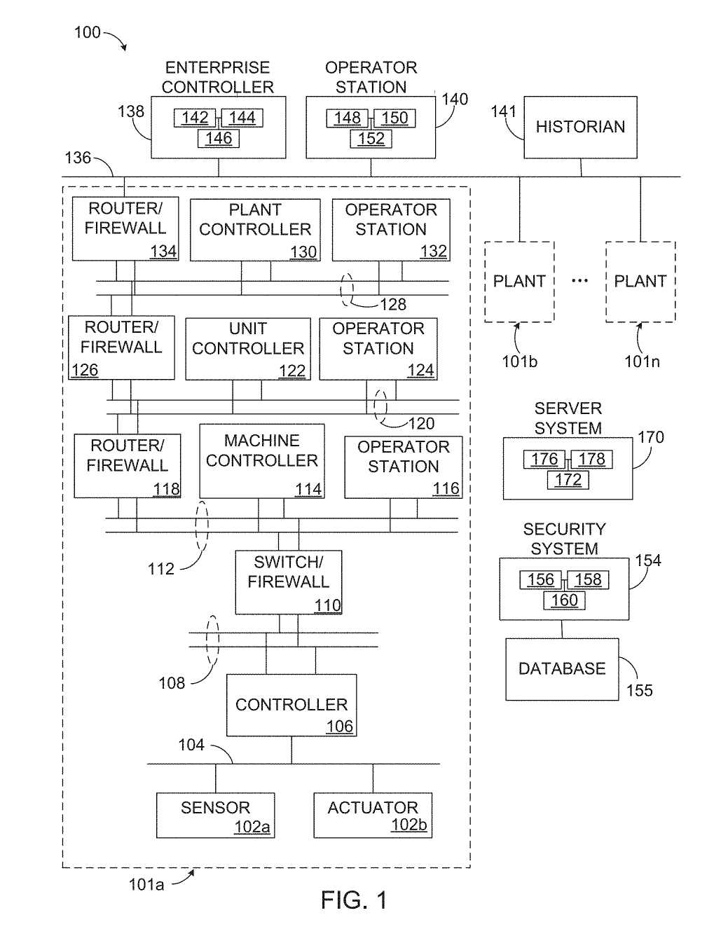

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

The security policy of a large enterprise has many elements and many points of enforcement. In current practice, the configuration of each point of enforcement is managed independently in order to implement the security policy as accurately as possible. Consequently, it is an expensive and unreliable proposition to modify the security policy. The eXtensible Access Control Markup Languge (XACML) Version 3.0 specification describes a common language for expressing security policy. Such a common policy language allows the enterprise to manage the enforcement of all the elements of its security policy in all the components of its information systems. As of time of filing, the XACML Version 3.0 specification can be located at docs.oasis-open.org/xacml/3.0/xacml-3.0-core-spec-en.pdf and is hereby incorporated by reference.

The processes and results described herein can be accomplished (among other ways) using a security system 154. Among other things, the security system 154 supports a technique for using Automated Security Policy Information Point (PIP) content generation.

In this example, the security system 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory or Flash memory. Each network interface 160 could represent an Ethernet interface, wireless transceiver, or other device facilitating external communication. The functionality of the security system 154 could be implemented using any suitable hardware or a combination of hardware and software/firmware instructions. In some embodiments, the security system 154 includes, or is in communication with, a database 155. The database 155 denotes any suitable structure facilitating storage and retrieval of information, and in particular can be used to store security PIP database content as described herein. The security system 154 can be used on any of the networks of FIG. 1, and is called out specifically here for clarity of description. In specific embodiments, security system 154 can be implemented as or on a personal computer system running a consumer operating system.

Disclosed embodiments can include a separate server system 170 in communication with the security system 154. Server system 170 can interact with security system 154 according to security policies defined, in whole or in part, by a security PIP as described herein, and can be a cloud server system (or combination of systems). In this example, the server system 170 includes one or more processing devices 176; one or more memories 178 for storing instructions and data used, generated, or collected by the processing device(s) 176; and at least one network interface 172. Each processing device 176 could represent a microprocessor, microcontroller, digital signal process, field programmable gate array, application specific integrated circuit, or discrete logic. Each memory 178 could represent a volatile or non-volatile storage and retrieval device, such as a random access memory or Flash memory. Each network interface 172 could represent an Ethernet interface, wireless transceiver, or other device facilitating network communication. The functionality of the server system 170 could be implemented using any suitable hardware or a combination of hardware and software/firmware instructions. The server system 170 can be, for example, a stand-alone data processing system, a mobile device, an external server or enterprise system, or otherwise. The exemplary structure of the server system 170 described above is not intended to limit the structure or function of the devices that could be used to implement the server system 170.

Although FIG. 1 illustrates one example of an industrial process control and automation system 100, various changes may be made to FIG. 1. For example, a control and automation system could include any number of sensors, actuators, controllers, servers, operator stations, networks, risk managers, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which the functions of the security system 154 can be used. This functionality can be used in any other suitable device or system.

Disclosed embodiments include techniques for automation of resource availability and the security access policies associated with the resources, and development of the security PIP by a system such as security system 154. Disclosed embodiments includes a method to automatically generate Security Policy Information Point (PIP) content for automation device types, and instances, by a security system.

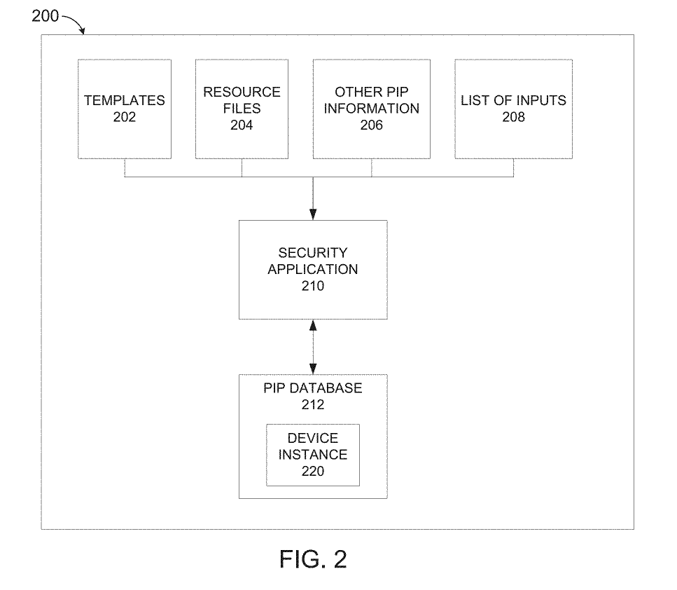

FIG. 2 illustrates logical elements of a system 200 in accordance with disclosed embodiments. System 200 can be implemented, for example, by security system 154.

System 200 includes templates 202, which can include, for example, a Security Policy Information Point Data Base policy template, a PIP device type template, and/or a device definition record template.

System 200 includes a set of resource files 204 which include device type resource information that describes automation device type resources. These files may be described by or include, for example, a set of Standardized General Markup Language (SGML) files, such as those based on the Electronic Device Description Language (EDDL) standard (IEC 61804-3). These files may be described by or include, for example, industry defined standard object ontologies. These files may be described by or include, for example, a set of files based on a consortium defined specification, such as for a single market domain. These files may be described by or include, for example, a set of files based on a single domain ontology or a set of cross-domain ontologies intended to provide cross-domain interoperability (e.g. for the Internet of Things). These files may be described by or include, for example, a set of vendor custom defined files. A security PIP database building application 210 as discussed above can display and receive selections of resources based on the resource files 204.

Other PIP information 206 can include information such as user classes and descriptive attributes for these classes who may attempt access. User classes here may include such classes as humans, devices, or applications. Users may be represented individually, or by membership in a group or sub-group (e.g., by job, such as “industrial automation system operators”, or by an application sub-group, such as one comprised of process configuration applications). The other PIP information 206 can include information defining the activities permitted for each user, such as view only access, read/write access, etc. The other PIP information 206 can include context-specific attributes such as temporal relationships, for instance the weekdays and hours for which access is granted, process related dynamic attributes, such as conditional access based on process or device state, or location attributes, such as conditional access based on the location and/or environment of a user, device, or other asset. The other PIP information 206 can also include contexts including those related to a particular set of events, conditions, or a set of events in conjunction with a set of conditions, as well as device deployment information.

System 200 includes a list of inputs 208 for use in building PIP database 212. These inputs can include physical or logical topologies, security requirements, user role definitions, or any other inputs useful in building a particular PIP database 212.

In some embodiments, templates 202, resource files 204, other PIP information 206, and list of inputs 208 can be received from a server system, such as server system 170, by a client system, such as security system 154, where the client system executes a security PIP database building application 210 as described below.

A security PIP database building application 210 can combine the device type resource information (e.g., object types and object.attributes) from the resource files 204 with a PIP device type template from templates 202 to create a corresponding collection of records in the PIP database 212. Each record can contain default attribute-based access controls (ABAC) associated with the resource types defined by a particular device type. The records in the PIP database 212 can be created based on any information in the templates 202, resource files 204, other PIP information 206, or list of inputs 208.

The following is a non-limiting example of the logical content of a device type record in the PIP database 212:

Device Vendor: Company X01
-- Device Type (Model): DT01
-- Device Version/Revision:
-- Standard Ontology Objects Supported
------ Industry Ind001
------------Industry Object Ind001_Obj_AO
------------ ...
------ Industry Ind002
------------Industry Object IndObj002_Obj_AI
------------- ...
-- Vendor Custom Object Types Supported
----- X01Obj001 defined_by Resource_File_X01Obj001
-- ...

The following is a non-limiting example of the logical content of an object type record in the PIP database 212:

Object Name “Object Num 1”
Object Type “O01”
Object Description
-Attributes
--- Attribute “A01”
----- Attribute Description
----- Attribute Type (e.g. Static, Input, Output,
etc.)
----- Attribute Data Type (e.g. Int32, enumerated
with list of enumeration values, etc.)
----- Valid Attribute Value Information
----- <etc.>
----- Context Independent Access (default) β not
included if context independent access does not
apply)
-------- User Class “U1”
-------- User Class “U2”
...
----- Context Dependent Access (Context Dependent
overrides Context Independent) (default)
---------Context C01
-------------User Class “U1”
-------------User Class “U2”
...
--- Attribute “A02”
...
-Actions
--- Action “ACT01”

The security PIP database building application 210 can instantiate a device instance record 220 (stored as part of PIP database 212) and its corresponding object instances. Populating context-specific data into the object and/or object.attribute instances of a device instance defines the security access policy for access to that device or device type and to information contained therein.

The security policy administrator may also manually, or using another application (e.g. importing from a spreadsheet), automatically instantiate a device instance record and its corresponding object instances.

The security PIP database building application 210 can create and store a definition of the security access policy for one or more identified accessible resources in the PIP database records.

PIP database 212 could be implemented to reside on any network of FIG. 1. For example, if created at the Enterprise level, the PIP database 212 could reside on network 136. If created at a plant level, the PIP database 212 could reside on network 128. PIP database 212 can be distributed, and thus reside on multiple, different networks, locations, or systems. For example, the enterprise may create an “enterprise-wide PIP” which then may be customized at the plant, creating a “site-specific PIP”.

This customization typically requires human involvement, so it is not shown here.

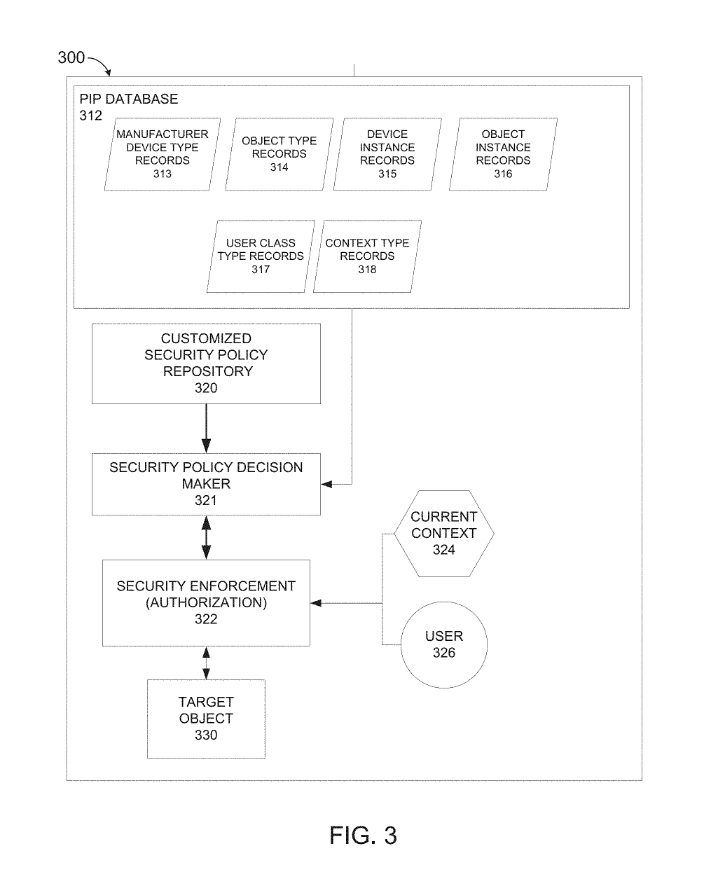

FIG. 3 illustrates logical elements of a security system 300, which could be implemented as security system 154, in accordance with disclosed embodiments. In this example, PIP database 312 includes manufacturer device type records 313, object type records 314, device instance records 315, object instance records 316, user class type records 317, and context type records 318. The user class type records 317 could be, for example, user role type such as operator, maintenance technician, etc. The context type records 318 could be, for example, an operational mode, environmental condition, etc.

Customized security policy repository 320 can include, for example, user class members or rules based on a combination of object(s)′ attributes. The security policy repository can include customized local policies received from a security policy administrator, other user, or other system.

The security policy decision maker 321 can be implemented as an attribute-based access control application, and can function to identify the applicable security policy.

Security enforcement element 322 enforces the applicable security policy. The security enforcement element 322 can receive inputs such as the current context 324 and the user 326. For example, the security enforcement element 322 can manage authorization to a target object 330, such as selectively permitting access based on one or more of an attribute access policy, a user identity or user role, a target object, a target attribute or action, or a context. Target object 330 can represent any device, system, application, or network as described herein.

PIP database 212 or 312 could be implemented to reside on any network of FIG. 1. For example, if created at the Enterprise level, PIP database 212 could reside on network 136. If created at a plant level, PIP database 212 or 312 could reside on network 128. PIP database 212 or 312 can reside on both networks, for example, if the enterprise creates an “enterprise-wide PIP” which then may be customized at the plant, creating a “site-specific PIP”.

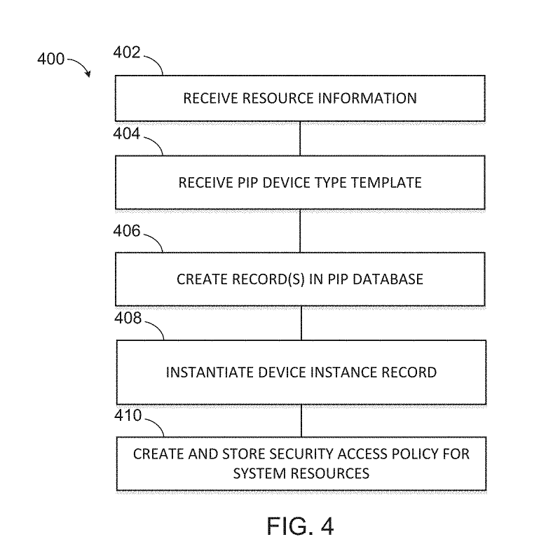

FIG. 4 illustrates a process 400 in accordance with disclosed embodiments. Such a process can be performed, for example, by a security application 210 executing on a security system 154, and is generally described as being performed by the “system” below.

The system receives resource information that describes automation device type resources (402). “Receiving” can include loading from storage, receiving from another device or process, receiving via an interaction with a user, or otherwise.

The system receives a PIP device type template (404).

The system creates at least one record in a PIP database according to the resource information and the PIP device type template (406). The record can also be based on other PIP information as described herein.

Using information from device instance records 315 and object instance records 316, the system instantiates device instance records derived from the corresponding PIP device type templates and corresponding object instance records in the PIP database (408). In some implementations, such devices instance records are created and populated for a PIP at a plant level, such as network 128 of FIG. 1. The collection of records in the PIP database represents security access information for the system resources represented in the PIP database.

The system creates and stores a security access policy definition for one or more system resources based on the PIP database (410). This can also be based on a Security Policy Information Point Data Base policy template.

Improvements using automation for PIP database creation as described herein improve productivity and promote consistent decision-making.

In some embodiments, the system can automatically propagate new enterprise level security policies or new policy updates to other systems. In doing so, the enterprise may define security policies which other or subordinate sites are typically expected to implement and leverage. When necessary, the security policy manager or other user at another site can perform any necessary local customization.

Customization can be used, for example, to reflect the actual system deployment, both physical (e.g., topologies, control system equipment, devices) as well as logical (e.g., based on deployed instances of ontology-defined objects).

Any of the specific steps described above can be modified, omitted, performed in a different order, or combined with any of the other features described herein.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving, by a security system, resource information that describes automation device type resources;
receiving, by the security system, a Policy Information Point (PIP) device type template; and
creating at least one record, by the security system, in a PIP database according to the resource information and the PIP device type template.

2. The method of claim 1, further comprising instantiating a device instance record from the at least one record in the PIP database.

3. The method of claim 1, further comprising creating and storing a security access policy definition for one or more system resources based on the PIP database.

4. The method of claim 3, wherein the security access policy definition is also based on a Security Policy Information Point Data Base policy template.

5. The method of claim 1, wherein the at least one record in the PIP database is also based on other PIP information, the other PIP information including at least one of user classes, information defining one or more activities permitted for users, and context-specific attributes.

6. The method of claim 1, wherein the resource information is included in a set of resource files that includes at least one of device type resource information that describes automation device type resources, a set of Standardized General Markup Language (SGML) files, a set of files based on a consortium defined specification, a set of files based on a single domain ontology or a set of cross-domain ontologies intended to provide cross-domain interoperability, or a set of vendor custom defined files.

7. The method of claim 1, wherein the at least one record contains default attribute-based access controls (ABAC) associated with resource types defined by a particular device type.

8. A security system comprising:
a controller; and
a memory, the controller configured to:
receive resource information that describes automation device type resources;
receive a Policy Information Point (PIP) device type template; and
create at least one record in a PIP database according to the resource information and the PIP device type template.

9. The security system of claim 8, wherein the controller is further configured to instantiate a device instance record from the at least one record in the PIP database.

10. The security system of claim 8, wherein the controller is further configured to create and store a security access policy definition for one or more system resources based on the PIP database.

11. The security system of claim 10, wherein the security access policy definition is also based on a Security Policy Information Point Data Base policy template.

12. The security system of claim 8, wherein the at least one record in the PIP database is also based on other PIP information, the other PIP information including at least one of user classes, information defining one or more activities permitted for users, and context-specific attributes.

13. The security system of claim 8, wherein the resource information is included in a set of resource files that includes at least one of device type resource information that describes automation device type resources, a set of Standardized General Markup Language (SGML) files, a set of files based on a consortium defined specification, a set of files based on a single domain ontology or set of cross-domain ontologies intended to provide cross-domain interoperability, or a set of vendor custom defined files.

14. The security system of claim 8, wherein the at least one record contains default attribute-based access controls (ABAC) associated with resource types defined by a particular device type.

15. A non-transitory machine-readable medium encoded with executable instructions that, when executed, cause one or more processors of a security system to:
receive resource information that describes automation device type resources;
receive a Policy Information Point (PIP) device type template; and
create at least one record in a PIP database according to the resource information and the PIP device type template.

16. The non-transitory machine-readable medium of claim 15, wherein the instructions, when executed, further cause the one or more processors of the security system to instantiate a device instance record from the at least one record in the PIP database.

17. The non-transitory machine-readable medium of claim 15, wherein the instructions, when executed, further cause the one or more processors of the security system to create and store a security access policy definition for one or more system resources based on the PIP database.

18. The non-transitory machine-readable medium of claim 17, wherein the security access policy definition is also based on a Security Policy Information Point Data Base policy template.

19. The non-transitory machine-readable medium of claim 15, wherein the at least one record in the PIP database is also based on other PIP information, the other PIP information including at least one of user classes, information defining one or more activities permitted for users, and context-specific attributes.

20. The non-transitory machine-readable medium of claim 15, wherein the resource information is included in a set of resource files that includes at least one of device type resource information that describes automation device type resources, a set of Standardized General Markup Language (SGML) files, a set of files based on a consortium defined specification, a set of files based on a single domain ontology or a set of cross-domain ontologies intended to provide cross-domain interoperability, or a set of vendor custom defined files.
